(19) United States
(12) Patent Application Publication
(10) Pub. No.: US 2018/0179326 A1
(43) Pub. Date: Jun. 28, 2018

(54) Polyurethane Foam Composition for Sound Absorbing Material

(71) Applicants: Hyundai Motor Company, Seoul (KR); Kia Motors Corporation, Seoul (KR); University of Seoul Industry Cooperation Foundation, Seoul (KR)

(72) Inventors: Ji Wan Kim, Hwaseong-si (KR); Jung Wook Lee, Bucheon-si (KR); Gi Wook Sung, Seoul (KR); Seok Kyeong Kim, Seoul (KR); Jin Seok Kim, Seoul (KR); Jung Hyeun Kim, Seoul (KR)

(21) Appl. No.: 15/786,084

(22) Filed: Oct. 17, 2017

(30) Foreign Application Priority Data
Dec. 28, 2016 (KR) 10-2016-0181659

(51) Int. Cl. C08G 18/63; C08J 9/12; C08J 9/00; C08G 18/12; C08G 18/48

(52) U.S. Cl. CPC C08G 18/632; C08J 9/125; C08J 9/0066; C08G 2101/00; C08G 18/48; C08J 2205/05; C08J 2375/08; C08G 18/12

(57) ABSTRACT

A polyurethane foam composition includes a polyol mixture that includes polyether polyol and polymer polyol, an isocyanate compound, a catalyst consisting of a resinizing catalyst and a foaming catalyst, a foaming agent, a chain extender, and a surfactant. The polymer polyol contained in the polyol mixture is present in an amount of 1% to 70% by weight, based on the total weigh of the polyol mixture. The polyether polyol has an average functional group number of 2 to 4 and a mass average molecular weight of 4000 to 8000. The polymer polyol is grafted or dispersed with 20 to 60 wt % of a solid polymer comprising a styrene monomer and acrylonitrile at a weight ratio of 9:1, in polyether polyol having an average functional group number of 2 to 4 and a mass average molecular weight of 3000 to 6000.

### CROSS-REFERENCE TO RELATED APPLICATIONS

This application claims under 35 U.S.C. § 119(a) the benefit of priority to Korean Patent Application No. 10-2016-0181659 filed on Dec. 28, 2016, the entire contents of which are incorporated herein by reference.

### TECHNICAL FIELD

The present disclosure relates to a polyurethane foam composition for a sound absorbing material.

### BACKGROUND

Not only excellent fuel efficiency and driving performance but also environmentally-friendliness and silence are important to vehicles. For excellent silence, various kinds of sound absorbing materials and sound insulation materials are used in the vehicle, and among the materials, polyurethane foam is the most used. Since a zone of noise generated in each part of the vehicle is different, polyurethane foam having a characteristic suitable for the part is used, and flexible polyurethane foam is used in dashboards, sheets, flooring, etc., which require high-frequency noise absorption.

Meanwhile, since sound absorption occurs by conversion of sound energy to thermal energy due to vibration of a sound wave entering into a cell, a lot of sound waves may enter into the cell and a structure which can be vibrated a lot has an advantage of sound absorption. Accordingly, the sound absorption of polyurethane foam is influenced by the open cell structure in the foam.

When the cell structure is closed, the shrinkage of the cell may be accompanied by the temperature drop in a cold curing process of the foamed foam, and thus the open cell structure is important in that the polyurethane foam having the closed cell structure when fabricating mold foam may cause a defect such as shrinkage in the process.

Meanwhile, since a cold curing foaming body forms a cell having a closed structure, an open-cellization process after demolding, that is, crushing is necessary. As a method of opening the cell having the closed structure, a crushing method of passing a foaming body between circular molds having a narrower distance than the foaming body and a cursing method of applying vacuum to the foaming body have been used.

As a result, due to the crushing process of the foaming body after demolding, productivity is deteriorated, and in order to prevent a problem due to shrinkage and the like, researches of a technology for making the foaming body have an open cell structure before demolding are required.

The above information disclosed in this Background section is only for enhancement of understanding of the background of the invention and therefore it may contain information that does not form the related art that is already known in this country to a person of ordinary skill in the art.

### SUMMARY

The present disclosure relates to a polyurethane foam composition for a sound absorbing material. In particular embodiments, the invention relates to a polyurethane foam composition for a sound absorbing material with improved sound absorption performance by generating an open cell structure of polymer polyol when foaming polyurethane foam.

Embodiments of the present invention can solve the above-described problems associated with related art. For example, embodiments are directed to providing a polyurethane foam composition for a sound absorbing material capable of improving sound absorption performance by generating an open cell structure of polymer polyol when foaming polyurethane foam.

In one aspect, the present invention provides a polyurethane foam composition for a sound absorbing material includes a polyol mixture comprising polyether polyol and polymer polyol, an isocyanate compound, a catalyst consisting of a resinizing catalyst and a foaming catalyst, a foaming agent, a chain extender, and a surfactant. The polymer polyol contained in the polyol mixture is present in an amount of 1% to 70% by weight, based on the total weigh of the polyol mixture. The polyether polyol has an average functional group number of 2 to 4 and a mass average molecular weight of 4000 to 8000. The polymer polyol is grafted or dispersed with 20 to 60 wt % of a solid polymer consisting of a styrene monomer and acrylonitrile with a weight ratio of 9:1, in polyether polyol having an average functional group number of 2 to 4 and a mass average molecular weight of 3000 to 6000.

In a preferred embodiment, the isocyanate compound may have the content of NCO group of 25 to 45% and an index of 0.7 to 1.2.

In another preferred embodiment, the polyurethane foam composition may include 0.5 to 1.5 wt % of the resinizing catalyst, 0.1 to 0.2 wt % of the foaming catalyst, 2 to 5 wt % of the foaming agent, 0.01 to 0.6 wt % of the chain extender; and 0.5 to 2 wt % of the surfactant.

In still another preferred embodiment, the foaming agent may be distilled water, the chain extender may be selected from the group consisting of diethanolamine, triethanolamine, 1,4-butanediol, and ethylenediamine, and the surfactant may be a silicon surfactant.

In another aspect, the present invention provides a method for preparing a polyurethane foam composition for a sound absorbing material. The method includes: foaming a raw material composition that includes a polyol mixture comprising polyether polyol and polymer polyol, an isocyanate compound, a catalyst comprising a resinizing catalyst and a foaming catalyst, a foaming agent, a chain extender, and a surfactant. The polymer polyol contained in the polyol mixture is present in an amount of 1% to 70% by weight, based on the total weigh of the polyol mixture. The polyether polyol has an average functional group number of 2 to 4 and a mass average molecular weight of 4000 to 8000. The polymer polyol is grafted or dispersed with 20 to 60 wt % of a solid polymer consisting of a styrene monomer and acrylonitrile with a weight ratio of 9:1, in polyether polyol having an average functional group number of 2 to 4 and a mass average molecular weight of 3000 to 6000.

According to the polyurethane foam composition for a sound absorbing material of the present invention, it is possible to improve sound absorption performance by generating an open cell structure of polymer polyol when foaming polyurethane foam by using the composition.

It is also possible to obtain high-elastic polyurethane with increased compression strength due to the use of polymer polyol having high viscosity and simplify a process by omitting a crushing process in the related art.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a graph illustrating a result of measuring sound absorption performance according to Test Example 1 of the present invention;

FIG. 2 is a graph illustrating a result of measuring sound absorption performance according to Test Example 2 of the present invention;

FIG. 3 is a graph illustrating a result of analyzing a pore type of polyurethane foam according to Test Example 2 of the present invention;

FIG. 4 is a graph illustrating a result of measuring air flow resistivity according to Test Example 3 of the present invention; and

FIG. 5 is a graph illustrating a result of measuring compression strength according to Test Example 3 of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF ILLUSTRATIVE EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention may have various modifications and various exemplary embodiments and specific exemplary embodiments will be illustrated in the drawings and described in detail in the detailed description. However, this does not limit the present invention to specific exemplary embodiments, and it should be understood that the present invention covers all the modifications, equivalents and replacements included within the spirit and technical scope of the present invention. In describing the present invention, when it is determined that the detailed description of the publicly known art related to the present invention may obscure the gist of the present invention, the detailed description thereof will be omitted.

The present invention provides a polyurethane foam composition for a sound absorbing material including a polyol mixture consisting of polyether polyol and polymer polyol, an isocyanate compound, a catalyst consisting of an isocyanate compound, a resinizing catalyst and a foaming catalyst, a foaming agent, a chain extender, and a surfactant, in which the polymer polyol contained in the polyol mixture is present in an amount of 1% to 70% by weight, based on the total weigh of the polyol mixture. the polyether polyol has an average functional group number of 2 to 4 and a mass average molecular weight of 4000 to 8000, and the polymer polyol is grafted or dispersed with 20 to 60 wt % of a solid polymer consisting of a styrene monomer and acrylonitrile with a weight ratio of 9:1, in polyether polyol having an average functional group number of 2 to 4 and a mass average molecular weight of 3000 to 6000.

In the related art, there is a problem in that productivity is deteriorated due to a crushing process of the foaming body after demolding. Therefore, the inventors verified through a test that when the weight ratio of the styrene monomer and acrylonitrile in the polymer polyol was adjusted, the polymer polyol generated an open cell structure to improve sound absorption performance and completed the invention.

A polyurethane foam composition for a sound absorbing material according to an aspect of the present invention includes a polyol mixture consisting of polyether polyol and polymer polyol, an isocyanate compound, a catalyst consisting of a resinizing catalyst and a foaming catalyst, a foaming agent, a chain extender, and a surfactant, in which the polymer polyol contained in the polyol mixture is present in an amount of 1% to 70% by weight, based on the total weigh of the polyol mixture. the polyether polyol has an average functional group number of 2 to 4 and a mass average molecular weight of 4000 to 8000, and the polymer polyol is grafted or dispersed with 20 to 60 wt % of a solid polymer consisting of a styrene monomer and acrylonitrile with a weight ratio of 9:1, in polyether polyol having an average functional group number of 2 to 4 and a mass average molecular weight of 3000 to 6000.

When a partially open pore ratio is increased in the polyurethane foam sound absorbing material, collision between sound energy and a polyurethane matrix may be increased and induced, and thus the partially open pore is important in the absorbing performance.

Hereinabove, the polymer polyol means that a solid polymer made from styrene monomer and acrylonitrile is grafted or dispersed in the polyether polyol.

The solid polymer is generated mainly by radical polymerization of vinyl monomers, and in this case, the more unstable the generated radical is, the higher the reactivity is, and thus the solid polymer tends to be grafted well. However, when the radical is stable, the reactivity is low and the solid polymer becomes unstable.

Since the acrylonitrile forms an unstable radical, the solid polymer is grafted well, but when the acrylonitrile is used alone, the acrylonitrile is discolored, and thus the acrylonitrile is mixed and used with the styrene monomer.

The polymer polyol content of the polyol mixture may be 3 to 70 wt % with respect to the entire polyol mixture. The reason is that when the polymer polyol content is less than 3 wt %, a change in physical property is too low and when the polymer polyol content is more than 70 wt %, the viscosity is too high and thus stirring is difficult.

The polyether polyol may use polyether polyol which is generally used, but may have an average functional group number of 2 to 4 and a mass average molecular weight of 4000 to 8000.

The polymer polyol is grafted or dispersed with 20 to 60 wt % of a solid polymer consisting of a styrene monomer and acrylonitrile with a weight ratio of 9:1, in polyether polyol having an average functional group number of 2 to 4 and a mass average molecular weight of 3000 to 6000.

According to the present invention, since hard segments are increased due to an increased in the benzene structure included in the styrene monomer, due to an increase in the degree of induced microphase separation, the partially open pores are increased, thereby inducing high sound absorption performance.

Hereinabove, the microphase separation means that the polyurethane matrix may be largely classified into a soft domain and a hard domain, each domain is configured by soft and hard segments, and as the microphase separation value is increased, the soft and hard domains are separated from each other and a partial phase is clearly distinguished, and as a result, a relatively soft part and a relatively hard part are exposed and the relatively soft part is torn or pierced by carbon dioxide generated in the foaming reaction and thus the ratio of the partially open pore is relatively increased.

Hereinabove, the partially open pores mean intermediate forms of open and close pores. When the ratio of partially open pores is high, propagation of sound energy in the polyurethane sound absorbing material, which is a porous material, is possible and the possibility of colliding with the matrix is increased, thereby securing high sound absorption performance.

Meanwhile, according to one aspect of the present invention, a solid polymer may consist of a styrene monomer and acrylonitrile with a weight ratio of 9:1, and the reason is that when only the styrene monomer is added and acrylonitrile is not added, a sedimentation phenomenon occurs and a problem in a process may occur, and in the case of a weight ratio of 9:1, the ratio of the partially open pores may be optimized to increase the sound absorption.

Hereinabove, the sedimentation phenomenon is a phenomenon in which the reactivity is deteriorated because the solid polymer is stable due to a resonance structure in a process of being radicalized in the absence of acrylonitrile, and thus, the chain connection is not performed well.

The isocyanate is not particularly limited, but may use monoisocyanate, diisocyanate and the like, and may use diisocyanate in the present invention. The diisocyanate used in the present invention may use at least one selected from the group consisting of toluene diisocyanate, diphenylmethane diisocyanate, torilene diisocyanate, and derivatives thereof.

In particular, in the present invention, a technique of the present invention can be applied to the isocyanate having an NCO index of 0.7 to 1.2, and the possible isocyanate may include various general special MDI products, such as Cosmonate CG3701S (manufactured by Kumho Mitsui Chemical) and KW 5029/1C-B (product by BASF).

The isocyanate compound may have the content of NCO group of 25 to 45% and an index of 0.7 to 1.2.

Meanwhile, in the present invention, the catalyst means a generally used catalyst as a catalyst which is used for preparing polyurethane.

The foaming agent may use water or cyclopentane, and the surfactant serves to prevent cells generated when the cell is formed in the foaming body from being merged and broken and adjust the uniform cells to be formed, and a kind of foaming agent is not particularly limited so long as the foaming agent is used in the art, but in terms of reactant dispersibility, an excellent silicon surfactant may be used.

The chain extender may be selected from the group consisting of diethanolamine, triethanolamine, 1,4-butanediol, and ethylenediamine, and preferably diethanolamine.

Hereinabove, the polyurethane foam composition may include 0.5 to 1.5 wt % of the resinizing catalyst, 0.1 to 0.2 wt % of the foaming catalyst, 2 to 5 wt % of the foaming agent, 0.01 to 0.6 wt % of the chain extender; and 0.5 to 2 wt % of the surfactant.

The reason is that when the content of the chain extender is less than 0.01 wt %, the degree of crosslinking is insufficient and when the content of the chain extender is more than 0.6 wt %, there is a problem that closed cells increase, and when the content of the surfactant is less than 0.5 wt %, the stability of the cells is reduced.

Coloring agents, fillers, and the like may be selectively added to the polyurethane foam composition.

According to another aspect of the present invention, a method for preparing polyurethane foam for a sound absorbing material may include foaming a raw material composition which includes a polyol mixture consisting of polyether polyol and polymer polyol; an isocyanate compound; a catalyst consisting of a resinizing catalyst and a foaming catalyst, a foaming agent, a chain extender; and a surfactant, in which the polymer polyol contained in the polyol mixture is present in an amount of 1% to 70% by weight, based on the total weigh of the polyol mixture. the polyether polyol has an average functional group number of 2 to 4 and a mass average molecular weight of 4000 to 8000, and the polymer polyol is grafted or dispersed with 20 to 60 wt % of a solid polymer consisting of a styrene monomer and acrylonitrile with a weight ratio of 9:1, in polyether polyol having an average functional group number of 2 to 4 and a mass average molecular weight of 3000 to 6000.

Hereinafter, Examples of the present invention will be described in detail with reference to the accompanying drawings. However, these Examples are just to exemplify the present invention, and it is interpreted that the scope of the present invention is not limited to these Examples.

The following examples illustrate the invention and are not intended to limit the same.

### Examples 1 to 6

Polyurethane foam was prepared by ingredients illustrated in Table 1 below.

In detail, after a resin mixture was prepared by mixing all ingredients except for isocyanate, the isocyanate and the resin mixture were stirred. After stirring, the mixture was injected into a mold preheated at 60° C. to grow foam and prepare polyurethane foam.

TABLE 1

| | | Ex. 1 | Ex. 2 | Ex. 3 | Ex. 4 | Ex. 5 | Ex. 6 |
|---|---|---|---|---|---|---|---|
| Polyol_main | KE-180 | 100 | 200 | 220 | 240 | 260 | 280 |
| Polyol_pop | Y-7320 | 200 | 100 | 80 | 60 | 40 | 20 |
| Cat. Gelling | NE1070 | 4.32 | 4.32 | 4.32 | 4.32 | 4.32 | 4.32 |
| Cat. Blowing | NE210 | 0.48 | 0.48 | 0.48 | 0.48 | 0.48 | 0.48 |
| Crosslinker | DEOA | 1.8 | 1.8 | 1.8 | 1.8 | 1.8 | 1.8 |
| Blowing Agent | Water | 10 | 10 | 10 | 10 | 10 | 10 |
| Surfactant | L-3002 | 3.93 | 3.93 | 3.93 | 3.93 | 3.93 | 3.93 |
| Isocyanate | KW-5029/1C-B | 123.918091 | 124.944829 | 125.150766 | 125.355524 | 125.560872 | 125.766219 |

### Example 7

Except that a weight ratio of styrene monomer:acrylonitrile included in the polymer polyol was 9:1 in the ingredients of Example 4, polyurethane foam was prepared equally to Examples.

### Comparative Examples 1 to 4

Except that a weight ratio of styrene monomer:acrylonitrile included in the polymer polyol was 1:9 (Comparative Example 1), 3:7 (Comparative Example 2), 5:5 (Comparative Example 3), or 7:3 (Comparative Example 4) in the ingredients of Example 4, polyurethane foam was prepared equally to Examples.

### Test Example 1

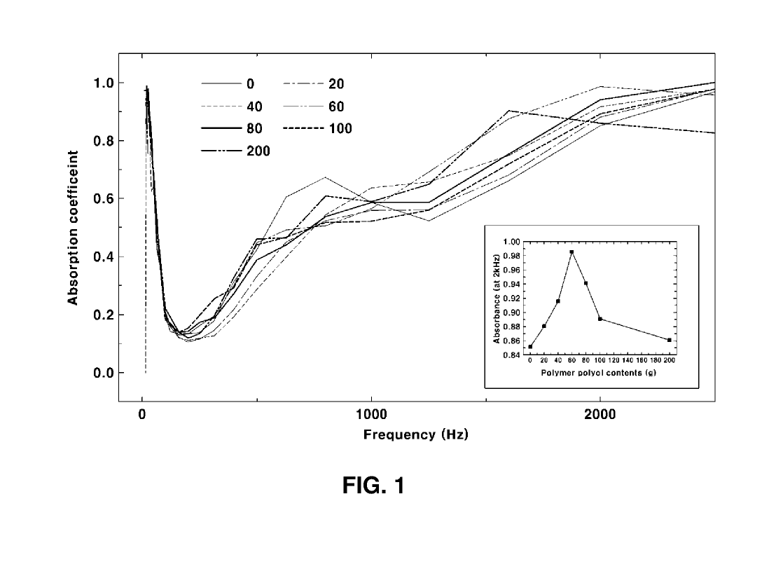

The polyurethane foam prepared according to Examples 1 to 6 was processed in a cylindrical form having a diameter of 10 cm and a height of 2 cm, and sound absorption performance was measured and illustrated in FIG. 1.

As illustrated in FIG. 1, it can be seen that the sound absorption performance in a high frequency area is entirely improved by adding polymer polyol. In particular, when comparing the sound absorption performance of a 2 kHz band, it can be seen that the sound absorption performance is most excellent when 60 g of the polymer polyol is added. The reason is that the polymer polyol makes a lot of open cells and thus sound waves are deeply penetrated and more attenuated.

### Test Example 2

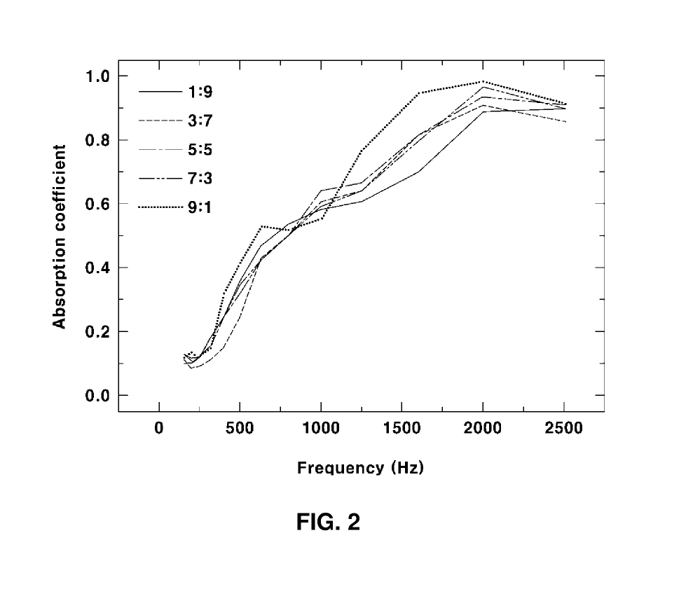

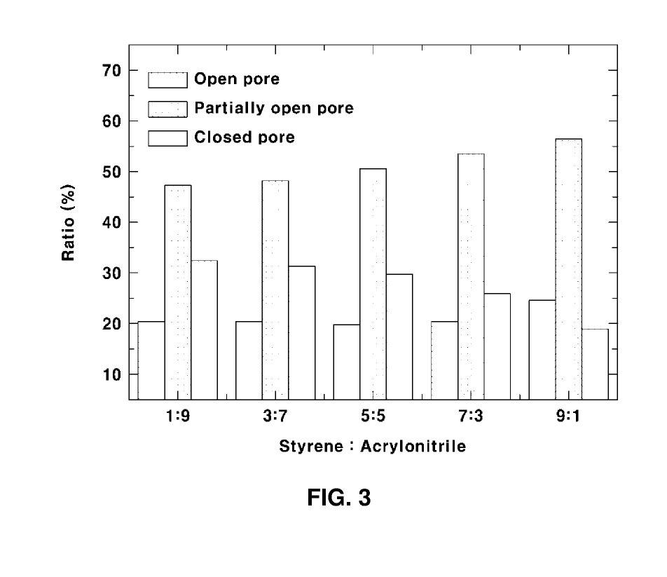

The polyurethane foam prepared according to Examples 7 to 6 was processed in a cylindrical form having a diameter of 10 cm and a height of 2 cm, and sound absorption performance was measured and illustrated in FIG. 2. Further, an analysis result of pore kinds of the polyurethane foam is illustrated in FIG. 3.

As the content of the styrene monomer is increased, a ratio of hard segments resulting from a characteristic of a benzene structure included in styrene is increased. As a result, the hard domains in the polyurethane matrix are increased and the degree of microphase separation is increased, and thus the ratio of partially open pores is increased as shown in the ratio result for each pore kind of FIG. 3.

Meanwhile, the microphase separation value induced by the increase of the styrene monomer content is increased, and as a result, the ratio of the partially opened pores is increased, thereby increasing the sound absorption performance of the polyurethane sound absorbing material. As illustrated in FIG. 2, it can be seen that in the case of the weight ratio of 9:1, the ratio of the partially opened pores is optimized and the sound absorption is increased.

### Test Example 3

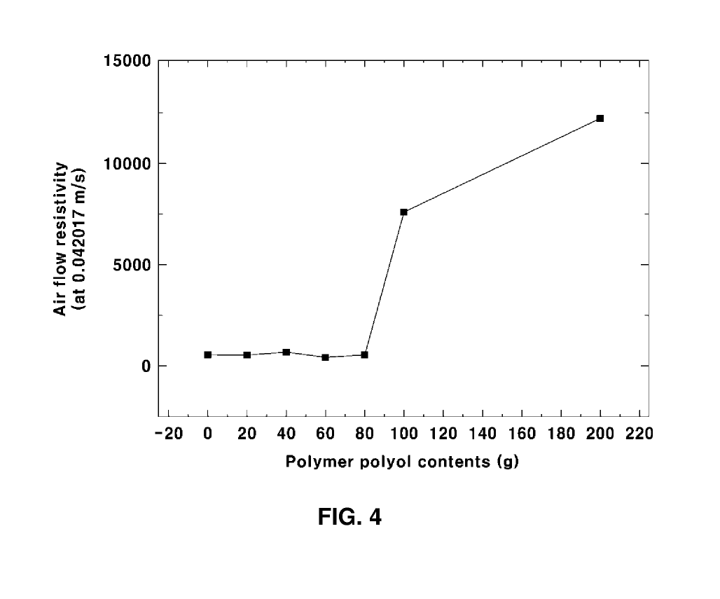

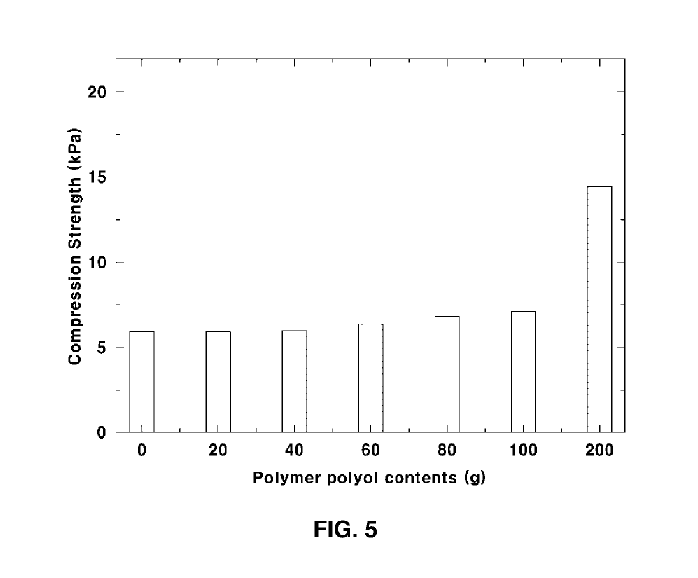

The polyurethane foam prepared according to Examples 1 to 6 was processed in a cylindrical form having a diameter of 10 cm and a height of 2 cm, and air flow resistivity and compression strength were measured and illustrated in FIGS. 4 and 5.

As illustrated in FIG. 4, since the content of the polymer polyol is 100 g, the air flow resistivity is rapidly increased. The reason is that because of the closed cell structure, the ratio of the open cells is decreased and thus air does not flow well.

As illustrated in FIG. 5, it can be seen that as the content of the polymer polyol is increased, the compression strength is increased. The reason is that the viscosity of the mixture is increased by adding the polymer polyol.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polyurethane foam composition, comprising:
a polyol mixture comprising polyether polyol and polymer polyol, an isocyanate compound, a catalyst consisting of a resinizing catalyst and a foaming catalyst, a foaming agent, a chain extender, and a surfactant;
wherein the polymer polyol contained in the polyol mixture is present in an amount of 1% to 70% by weight, based on the total weigh of the polyol mixture;
wherein the polyether polyol has an average functional group number of 2 to 4 and a mass average molecular weight of 4000 to 8000; and
wherein the polymer polyol is grafted or dispersed with 20 to 60 wt % of a solid polymer comprising a styrene monomer and acrylonitrile at a weight ratio of 9:1, in polyether polyol having an average functional group number of 2 to 4 and a mass average molecular weight of 3000 to 6000.

2. The polyurethane foam composition of claim 1, wherein the isocyanate compound has the content of NCO group of 25 to 45% and an index of 0.7 to 1.2.

3. The polyurethane foam composition of claim 1, wherein the polyurethane foam composition comprises 0.5 to 1.5 wt % of the resinizing catalyst, 0.1 to 0.2 wt % of the foaming catalyst, 2 to 5 wt % of the foaming agent, 0.01 to 0.6 wt % of the chain extender; and 0.5 to 2 wt % of the surfactant.

4. The polyurethane foam composition of claim 3, wherein the foaming agent comprises distilled water.

5. The polyurethane foam composition of claim 4, wherein the surfactant is a silicon surfactant.

6. The polyurethane foam composition of claim 5, wherein the chain extender is selected from the group consisting of diethanolamine, triethanolamine, 1,7-butanediol, and ethylenediamine.

7. The polyurethane foam composition of claim 1, wherein the foaming agent comprises distilled water.

8. The polyurethane foam composition of claim 7, wherein the surfactant is a silicon surfactant.

9. The polyurethane foam composition of claim 7, wherein the chain extender is selected from the group consisting of diethanolamine, triethanolamine, 1,4-butanediol, and ethylenediamine.

10. The polyurethane foam composition of claim 1, wherein the chain extender is selected from the group consisting of diethanolamine, triethanolamine, 1,7-butanediol, and ethylenediamine.

11. The polyurethane foam composition of claim 1, wherein the surfactant is a silicon surfactant.

12. A sound absorbing material comprising the polyurethane foam composition of claim 1.

13. A polyurethane foam composition for a sound absorbing material, comprising:
a polyol mixture consisting of polyether polyol and polymer polyol, an isocyanate compound, a catalyst consisting of a resinizing catalyst and a foaming catalyst, a foaming agent, a chain extender; and a surfactant;
wherein the polymer polyol contained in the polyol mixture is present in an amount of 1% to 70% by weight, based on the total weigh of the polyol mixture;
wherein the polyether polyol has an average functional group number of 2 to 4 and a mass average molecular weight of 4000 to 8000; and
wherein the polymer polyol is grafted or dispersed with 20 to 60 wt % of a solid polymer consisting of a styrene monomer and acrylonitrile at a weight ratio of 9:1, in polyether polyol having an average functional group number of 2 to 4 and a mass average molecular weight of 3000 to 6000.

14. A method for preparing polyurethane foam for a sound absorbing material, the method comprising:
foaming a raw material composition that comprises a polyol mixture comprising polyether polyol and polymer polyol; an isocyanate compound; a catalyst that comprises a resinizing catalyst and a foaming catalyst, a foaming agent, a chain extender; and a surfactant;
wherein the polymer polyol contained in the polyol mixture is present in an amount of 1% to 70% by weight, based on the total weigh of the polyol mixture;
wherein the polyether polyol has an average functional group number of 2 to 4 and a mass average molecular weight of 4000 to 8000; and
wherein the polymer polyol is grafted or dispersed with 20 to 60 wt % of a solid polymer consisting of a styrene monomer and acrylonitrile with a weight ratio of 9:1, in polyether polyol having an average functional group number of 2 to 4 and a mass average molecular weight of 3000 to 6000.

15. The method of claim 14, wherein the isocyanate compound has the content of NCO group of 25 to 45% and an index of 0.7 to 1.2.

16. The method of claim 14, wherein the polyurethane foam comprises 0.5 to 1.5 wt % of the resinizing catalyst, 0.1 to 0.2 wt % of the foaming catalyst, 2 to 5 wt % of the foaming agent, 0.01 to 0.6 wt % of the chain extender; and 0.5 to 2 wt % of the surfactant.

17. The method of claim 14, wherein the foaming agent is distilled water.

18. The method of claim 14, wherein the chain extender is selected from the group consisting of diethanolamine, triethanolamine, 1,7-butanediol, and ethylenediamine.

19. The method of claim 14, wherein the surfactant is a silicon surfactant.
